(19) United States
(12) Patent Application Publication
(10) Pub. No.: US 2014/0319955 A1
(43) Pub. Date: Oct. 30, 2014

(54) STATOR FOR AN ELECTRICAL MACHINE

(71) Applicants: Mark Edward Leaver, Newcastle (GB); Stephen Greetham, Gloucester (GB); Kenneth Lee, Swindon (GB)

(72) Inventors: Mark Edward Leaver, Newcastle (GB); Stephen Greetham, Gloucester (GB); Kenneth Lee, Swindon (GB)

(73) Assignee: Dyson Technology Limited, Malmesbury, Wiltshire (GB)

(21) Appl. No.: 14/351,482

(22) PCT Filed: Dec. 23, 2011
(86) PCT No.: PCT/GB2011/052583

§ 371 Date: May 16, 2014

(30) Foreign Application Priority Data
Oct. 14, 2011 (GB) 1117770.6

(51) Int. Cl. H02K 3/18; H02K 3/34; H02K 1/08

(52) U.S. Cl. CPC H02K 3/18; H02K 1/08; H02K 3/345
USPC 310/208

(57) ABSTRACT

A stator comprising a coil wound onto a bobbin. The coil is wound as a plurality of layers, each layer comprising a plurality of turns that extend between opposite ends of the bobbin. The outermost layer has a turn pitch greater than that of a lower layer. Additionally, an electrical machine comprising the stator.

### REFERENCE TO RELATED APPLICATIONS

This application is a national stage application under 35 USC 371 of International Application No. PCT/GB2011/052583, filed Dec. 23, 2011, which claims the priority of United Kingdom Application No. 1117770.6, filed Oct. 14, 2011, the entire contents of which are incorporated herein by reference.

### FIELD OF THE INVENTION

The present invention relates to a stator for an electrical machine, and to an electrical machine incorporating the same.

### BACKGROUND OF THE INVENTION

The coil of a stator is typically wound onto a bobbin. The size of the bobbin is generally defined such that, for a given wire diameter and number of turns, the first and last turns of the coil are located at an end of the bobbin. This then enables the free ends of the coil to be coupled to electrical terminals whilst maintaining the coil under tension.

It may be necessary to use different coil configurations with the same stator. For example, the mains power supply in many countries differs in voltage and/or frequency and thus a coil having a different wire diameter and/or number of turns may be required. For each coil configuration, a different bobbin is generally required in order that the first and last turns are located at an end of the bobbin. However, the provision of different bobbins increases the cost of production.

### SUMMARY OF THE INVENTION

In a first aspect, the present invention provides a stator comprising a coil wound onto a bobbin, the coil being wound as a plurality of layers, each layer comprising a plurality of turns extending between opposite ends of the bobbin, wherein the outermost layer has a turn pitch greater than that of a lower layer.

The outermost layer therefore has fewer turns than that of the lower layer. Since the turns of the outermost layer extend between opposite ends of the bobbin, the coil may be maintained under tension. Accordingly, different coil configurations may be used with the same bobbin without any loss of tension.

The term ‘turn pitch’ should be understood to mean the centre-to-centre distance between adjacent turns. The outermost layer may have a turn pitch that is uniform or non-uniform over the length of layer. Nevertheless, the turn pitch of the outermost layer, as averaged over the full length of the layer, is greater than that of the lower layer.

The first turn of the coil may begin and the last turn of the coil may end at the same end of the bobbin. In particular, the first and last turns may begin and end at the rear of the bobbin. Electrical terminals for coupling the coil to a circuit board or the like may then be located at the same end of the bobbin. This then simplifies the assembly of the stator within an electrical machine. Additionally, should the stator comprise an additional coil, the ends of the two coils can be conveniently coupled together, if need be.

The layer immediately below the outermost layer may have a greater turn pitch than that of a lower layer. In particular, the outermost layer and the layer immediately below the outermost layer may have the same turn pitch. As a result, the coil may be wound such that the first and last turns of the coil begin and end at same end of bobbin, irrespective of the coil configuration.

The turns of the outermost layer and the turns of the layer immediately below the outermost layer may create a crisscross pattern. As a result, the turns of the outermost layer pin down the turns of the layer immediately below. The turns of the outermost layer may then be maintained under tension without the turns of the two layers migrating to an end of the bobbin. The turns may crisscross at the top and at the bottom of the bobbin, and the turns may lie alongside one another at the sides of the bobbin. Consequently, the turns of the two layers lie in the same plane along the sides of the bobbin. As a result, a relatively high fill factor may be achieved.

The stator may comprise a c-shaped core having a back and a pair of arms extending from opposite ends of the back. The bobbin may then be provided on one of the arms, and the stator may comprise a further bobbin provided on the other of the arms. A further coil may be wound onto the further bobbin, the further coil being wound as a plurality of layers, each layer comprising a plurality of turns extending between opposite ends of the further bobbin. The outermost layer of the further coil then has a turn pitch greater than that of a lower layer. Since the turns of the outermost layer of each coil extends between opposite ends of the bobbin, magnetic flux leakage between the arms of the stator may be reduced.

In a second aspect, the present invention provides an electrical machine comprising a rotor and a stator as claimed in any one of the preceding paragraphs.

In a third aspect, the present invention provides an electrical machine comprising a rotor and a stator, the stator comprising a plurality of stator elements arranged around the rotor, each stator element comprising a core, a bobbin and a coil, the coil being wound onto the bobbin as a plurality of layers, each layer comprising a plurality of turns extending between opposite ends of the bobbin, wherein the outermost layer has a turn pitch greater than that of a lower layer.

Since the turns of the outermost layer of the coil extends between opposite ends of the bobbin, the coil of each stator element may be maintained under tension. Additionally, magnetic flux leakage between stator elements may be reduced.

Each stator element may comprise a further bobbin and a further coil, the further coil being wound onto the further bobbin as a plurality of layers, each layer comprising a plurality of turns extending between opposite ends of the further bobbin. The outermost layer of the further coil then has a turn pitch greater than that of a lower layer. By providing a further coil about the core of each stator element, magnetic flux leakage may be further reduced.

The core may be c-shaped and comprise a back and a pair of arms extending from opposite ends of the back. The bobbin is then provided on one of the arms, and the further bobbin is provided on the other of the arms. Since each bobbin is provided on an arm of the core, magnetic flux leakage between the arms may be reduced.

### BRIEF DESCRIPTION OF THE DRAWINGS

In order that the present invention may be more readily understood, an embodiment of the invention will now be described, by way of example, with reference to the accompanying drawings, in which:

FIG. 1 is a sectional top view of an electrical machine in accordance with the present invention, the section being taken along the line Y--Y of FIG. 3;

FIG. 2 is a top view of the electrical machine;

FIG. 3 is a sectional side view of the electrical machine, the section being taken along the line X--X of FIG. 2;

FIG. 4 is a sectional top view of a part of a stator not in accordance with the present invention; and

FIG. 5 is a sectional top view of a part of a further stator not in accordance with the present invention.

### DETAILED DESCRIPTION OF THE INVENTION

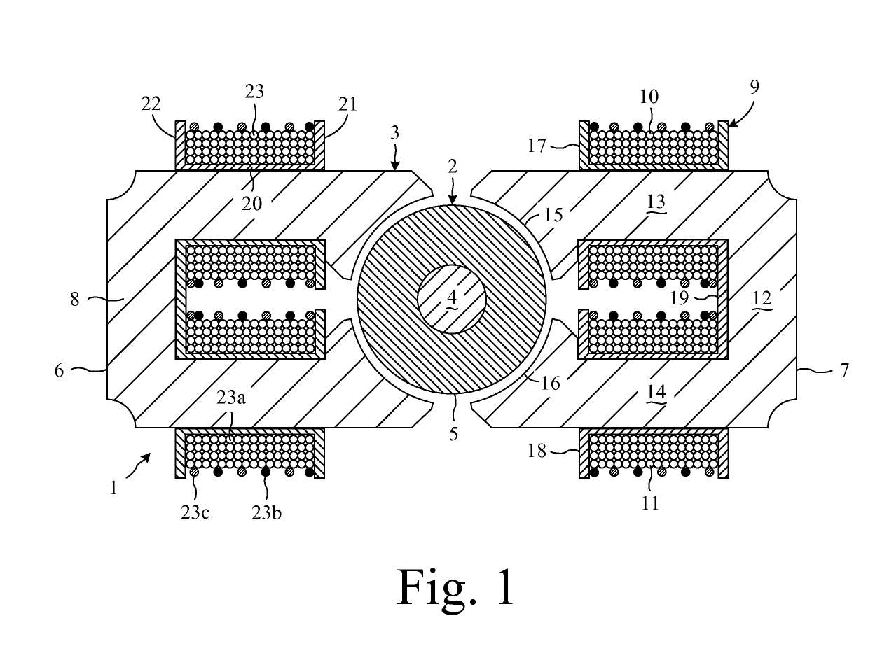

The electrical machine 1 of FIGS. 1 to 3 comprises a rotor 2 and a stator 3. The rotor 2 comprises a four-pole permanent magnet 4 supported on a shaft 5. The stator 3 comprises two stator elements 6,7 arranged on opposite sides of the rotor 2.

Each stator element 6,7 comprises a core 8, a bobbin element 9, and a pair of coils 10,11.

The core 8 is generally c-shaped and comprises a back 12 and two arms 13,14 that extend from opposite ends of the back 12. Each arm 13,14 extends toward the rotor 2 and has a free end that defines a pole face 15,16.

The bobbin element 9 comprises two bobbins 17,18 joined together by a bridging wall 19. Each bobbin 17,18 comprises a hollow tube 20, a front flange 21 and a rear flange 22, each flange 21,22 extending outwardly from an end of the tube 20. The hollow tube 20 of each bobbin 17,18 surrounds an arm 13,14 of the core 8. The front flange 21 is then proximal to the pole face 15,16, and the rear flange 22 is distal to the pole face 15,16. The bridging wall 19 extends between and joins the rear flanges 22 of the two bobbins 17,18.

Each coil 10,11 comprises a wire that is wound about a respective bobbin 17,18. A single wire may be used for both coils 10,11 of a stator element 6,7. Alternatively, separate wires may be used for each coil 10,11. Each coil 10,11 comprises a plurality of layers 23, each layer 23 having a plurality of turns that extend between opposite ends of the bobbin 17,18, as delimited by the flanges 21,22. With the exception of the outermost layer 23c and the layer immediately below the outermost layer 23b, each layer 23a of the coil 10,11 has the same turn pitch. The lower layers 23a therefore have the same or approximately the same number of turns. The actual number of turns may differ slightly between adjacent layers owing to the manner in which the turns overlie one another.

The outermost layer 23c and the layer immediately below the outermost layer 23b, which for the purposes of brevity shall hereafter be referred to as the adjacent layer 23b, have a greater turn pitch that that of the lower layers 23a. Moreover, the outermost layer 23c and the adjacent layer 23b have the same turn pitch and thus the same or approximately the same number of turns. For the purposes of clarity, the turns of the lower layers 23a are unshaded in FIGS. 1-3, whilst the turns of the adjacent layer 23b are fully shaded and the turns of the outermost layer 23c are partly shaded.

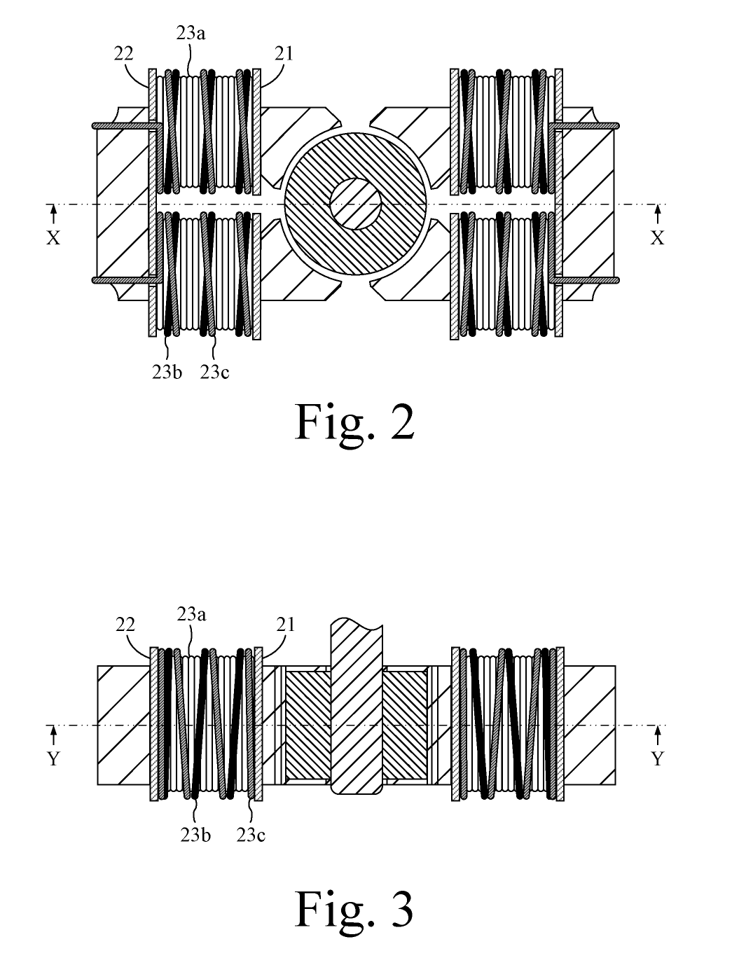

The turns of the outermost layer 23c and the turns of the adjacent layer 23b together create a crisscross pattern. In particular, the turns of the outermost layer 23c cross over the turns of the adjacent layer 23b at the top and bottom of the bobbin 17,18, as can be seen in FIG. 2. The turns of the outermost layer 23c and the turns of the adjacent layer 23b then lie alongside one another along the two sides of the bobbin 17,18, as can be seen in FIG. 3.

By employing a greater turn pitch for the outermost layer 23c and the adjacent layer 23b, different configurations (e.g. wire diameter and number of turns) for each coil 10,11 may be used with the same bobbin 17,18. Since each layer 23 of the coil 10,11 extends along the length of the bobbin 17,18, the first turn of the coil 10,11 begins and the last turn of the coil 10,11 ends at an end of the bobbin 17,18. Consequently, each coil 10,11 may be maintained under tension irrespective of the configuration that is employed.

In creating a crisscross pattern, the turns of the outermost layer 23c act to pin down the turns of the adjacent layer 23b. The turns of the outermost layer 23c can then be maintained under tension without the turns of both the outermost layer 23c and the adjacent layer 23b migrating to the rear of the bobbin 17,18.

The turns of the outermost layer 23c and the turns of the adjacent layer 23b lie alongside one another at the sides of the bobbin 17,18. Consequently, the turns of the two layers 23b,23c lie in the same plane along the sides of the bobbin 17,18, as can be seen in FIG. 1. As a result, a relatively high fill factor may be achieved for each stator element 6,7.

The total number of turns for each coil 10,11 is dictated by the electromagnetic requirements of the stator 3. In the particular embodiment illustrated in FIGS. 1-3, each coil 10,11 has 70 turns. However, for the given wire diameter of the coil 10,11, the bobbin 17,18 can accommodate a maximum of 16 turns along its length. It is for this reason that the outermost layer 23c and the adjacent layer 23b have fewer turns that those of lower layers 23a. The first four layers 23a (i.e. the lower layers) each have 16 turns, the fifth layer 23b (i.e. the adjacent layer) has 3 turns, and the sixth layer 23c (i.e. the outermost layer) has 3 turns.

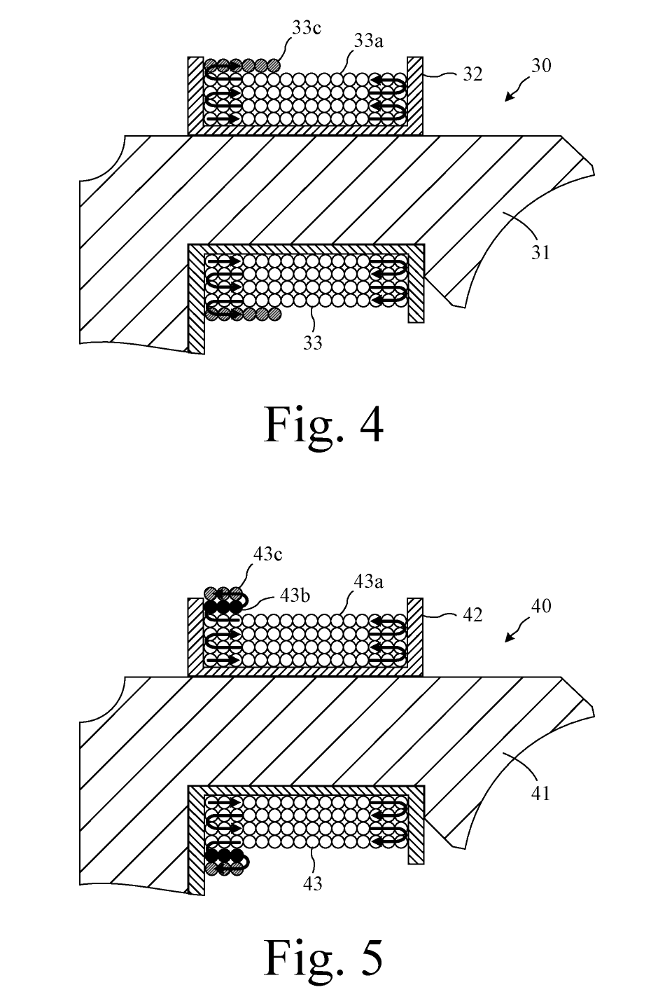

Alternative ways exist for winding 70 turns onto each bobbin 17,18. For example, FIG. 4 illustrates a stator 30 in which the first four layers 33a each have 16 turns and the fifth layer 33c (i.e. the outermost layer) has 6 turns. The arrows indicate the direction in which each layer 33 is wound onto the bobbin 32. A problem with this arrangement is that the last turn of the coil 33 terminates partway along the length of the bobbin 32. The wire forming the coil 33 must therefore return to the rear of the bobbin 32. As a result, the turns of the outermost layer 33c are not maintained under tension and may expand and migrate to the rear of the bobbin 32. This would then adversely affect the electromagnetic performance of the stator 30. FIG. 5 illustrates an alternative stator 40 that addresses this problem. The first four layers 43a each have 16 turns, the fifth layer 43b (i.e. the adjacent layer) has 3 turns and the sixth layer 43c (i.e. the outermost layer) has 3 turns. The last turn of the coil 43 is now located at the rear of the bobbin 42 and thus the turns are maintained under tension. However, in comparison to the stator 3 illustrated in FIGS. 1-3, the stator 40 of FIG. 5 suffers from increased inductance, as will now be explained.

During operation of the electrical machine 1, magnetic flux leaks between the two stator elements 6,7 as well as between the two arms 13,14 of each stator element 6,7. This magnetic flux leakage increases the inductance of the stator 3. Each coil 10,11 acts as a barrier to magnetic flux leakage. Consequently, magnetic flux leakage is reduced at those areas of the core 8 about which the coils 10,11 are wound. Moreover, as the number of turns increases about a particular part of the core 8, magnetic flux leakage from that part of the core 8 decreases.

With the stator 40 illustrated in FIG. 5, the turns of the outermost layer 43c and the adjacent layer 43b extend along a fifth only of the length of the bobbin 42. Moreover, the turns of these two layers 43b,43c are located at the rear of the bobbin 42. As a result, there is increased magnetic flux leakage from the front part of each arm of the core 41, i.e. that part not covered by the outermost and adjacent layers 43b,43c. There is therefore increased magnetic flux leakage between the two stator elements and between the arms of each stator element. In contrast, with the stator 3 illustrated in FIGS. 1-3, the turns of the outermost layer 23c and the adjacent layer 23b extend along the full length of each bobbin 17,18. Accordingly, magnetic flux leakage between the arms 13,14 of each core 8 is reduced. Additionally, since there are turns located at the front end of each bobbin 17,18, magnetic flux leakage between the two stator elements 6,7 is reduced. The stator 3 of FIG. 1-3 therefore has the advantage of reduced inductance whilst ensuring that the turns of each coil 10,11 are maintained under tension.

With the stator 3 illustrated in FIGS. 1-3, the outermost layer 23c and the adjacent layer 23b each have a greater turn pitch than that of lower layers 23a. However, depending on the required number of turns, the adjacent layer 23b may have the same turn pitch as that of the lower layers 23a. For example, if each coil 10,11 had 85 turns then the first five layers 23a,23b might each have 16 turns and the outermost layer 23c might have 5 turns. Alternatively, the first four layers 23a might each have 16 turns, the adjacent layer 23b might have 11 turns, and the outermost layer 23c might have 10 turns. It is not therefore essential that the adjacent layer 23b has the same turn pitch or number of turns as that of the outermost layer 23c.

The outermost layer 23c and the adjacent layer 23b each have a uniform turn pitch, which is to say that the turn pitch does not vary along the length of the layer. Alternatively, however, the outermost layer 23c and/or the adjacent layer 23b may have a non-uniform turn pitch. More particularly, the turn pitch may be smaller at the front end of the bobbin 17,18. Consequently, more turns are located at the front end of the bobbin 17,18 and thus magnetic flux leakage between stator elements 6,7 may be further reduced. Although the turn pitch may be non-uniform, the average turn pitch over the full length of the outermost layer 23c and/or the adjacent layer 23b is nevertheless greater than that of the lower layers 23a.

With the stator 3 illustrated in FIGS. 1-3, the first turn of each coil 10,11 begins and the last turn of each coil 10,11 ends at the same end of the bobbin 17,18. Where separate wires are used for the coils 10,11 of each stator element 6,7, a free end of one wire may then be conveniently coupled to a free end of the other wire so as to form a single phase winding. Additionally, electrical terminals (not shown) for coupling the coils 10,11 to a circuit board or the like may be located at the same end of the bobbin 17,18. For example, each flange 21,22 of the bobbin 17,18 may include a recess into which an electrical terminal is located. This then simplifies the assembly of the stator 3 within the electrical machine 1. In the embodiment illustrated in FIGS. 1-3, the coils 10,11 are wound on to the bobbins 17,18 in the same direction as that illustrated in FIGS. 4 and 5. Consequently, the first turn of each coil 10,11 begins and the last turn ends at the rear of each bobbin 17,18. This then has the advantage that electrical terminals can be located at the rear of the bobbin 17,18, where there is generally more space. Conceivably, however, the coils 10,11 might be wound about the bobbins 17,18 such that the first turn begins and the last turn ends at the front of the bobbin 17,18.

1. A stator comprising a coil wound onto a bobbin, the coil being wound as a plurality of layers, each layer comprising a plurality of turns extending between opposite ends of the bobbin, wherein the outermost layer has a turn pitch greater than that of a lower layer.

2. The stator of claim 1, wherein the first turn of the coil begins and the last turn of the coil ends at the same end of the bobbin.

3. The stator of claim 1, wherein the layer immediately below the outermost layer has a greater turn pitch than that of a lower layer.

4. The stator of claim 1, wherein the outermost layer and the layer immediately below the outermost layer have the same turn pitch.

5. The stator of claim 1, wherein the turns of the outermost layer and the layer immediately below the outermost layer create a crisscross pattern.

6. The stator of claim 5, wherein the turns crisscross at the top and at the bottom of the bobbin, and the turns lie alongside one another at the sides of the bobbin.

7. The stator of claim 1, wherein the stator comprises a c-shaped core having a back and a pair of arms extending from opposite ends of the back, the bobbin is provided on one of the arms, and the stator comprises a further bobbin provided on the other of the arms and a further coil wound onto the further bobbin, the further coil being wound as a plurality of layers, each layer comprising a plurality of turns extending between opposite ends of the further bobbin, wherein the outermost layer has a turn pitch greater than that of a lower layer.

8. An electrical machine comprising a rotor and a stator of claim 1.

9. An electrical machine comprising a rotor and a stator, the stator comprising a plurality of stator elements arranged around the rotor, each stator element comprising a core, a bobbin and a coil, the coil being wound onto the bobbin as a plurality of layers, each layer comprising a plurality of turns extending between opposite ends of the bobbin, wherein the outermost layer has a turn pitch greater than that of a lower layer.

10. The electrical machine of claim 9, wherein each stator element comprises a further bobbin and a further coil, the further coil being wound onto the further bobbin as a plurality of layers, each layer comprising a plurality of turns extending between opposite ends of the further bobbin, wherein the outermost layer has a turn pitch greater than that of a lower layer.

11. The electrical machine of claim 10, wherein the core is c-shaped and comprises a back and a pair of arms extending from opposite ends of the back, the bobbin is provided on one of the arms, and the further bobbin is provided on the other of the arms.
